(19) United States
(12) Patent Application Publication
(10) Pub. No.: US 2006/0279251 A1
(43) Pub. Date: Dec. 14, 2006

(54) Adjustable charger

(76) Inventors: Nicolas E. Guyot, Pompano Beach, FL (US); Daniel C. Acero, Miramar, FL (US); Orlando Hernandez, Sunrise, FL (US); Miguel A. Morales, Miami Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/149,892

(22) Filed: Jun. 10, 2005

(51) Int. Cl. H02J 7/00

(52) U.S. Cl. 320/107

(57) ABSTRACT

The invention concerns an adjustable charger (100) and a method (700) of using same. The adjustable charger can include a base portion (110) and an adjustable cradle (112) that can receive a single unit electronic device (130) having a display (132) or a flip-type electronic device (134) having a display (136). The adjustable cradle can position the single unit electronic device in a first viewing position and can position the flip-type electronic device in a second viewing position. In one arrangement, the first viewing position can be an optimal viewing position for a display of the single unit electronic device. In addition, the second viewing position can be an optimal viewing position for a display of the flip-type electronic device.

### BACKGROUND OF THE INVENTION

1. Field of the Invention

This invention relates in general to chargers and more particularly, to chargers that charge portable electronic devices.

2. Description of the Related Art

The use of portable electronic devices has exploded in recent years. Cellular telephones, in particular, have become quite popular with the public. These devices are typically designed in one of two ways: (1) a monolith or candy bar type of phone; and (2) a flip type of phone in which a flip portion is rotatably coupled to a base portion. The body of a monolith phone generally runs along a vertical axis; however, when in the open position, the flip portion and the base portion of the flip-type phone remain at an angle. This positioning permits the flip-type phone to follow the contour of a user's face when the user is participating in a call.

Because they are typically powered from rechargeable batteries, manufacturers will offer various charging units for sale to consumers who buy cellular telephones. Some of these charging units are desktop chargers, which are positioned on a flat surface and can receive a corresponding cellular telephone in an upright or vertical position.

In addition, monolith and flip-type phones include displays as part of their basic structure. The capabilities of these displays have increased over time, to the point where most of them are relatively large in size and have the capability to display colors. Despite these advances, these displays are still sensitive to the viewing angle relative to the user looking at the display. For example, if a display is moved, the ability of the user to clearly see the display may be reduced.

Because flip-type phones remain at an angle in the open position and the monolith phones typically run along a vertical axis, separate desktop chargers must be developed for these phone types to optimize the viewing angle of the displays when the phones are placed in the chargers. This separate production of desktop chargers, however, leads to increased costs and a less efficient use of inventory.

### SUMMARY OF THE INVENTION

The present invention concerns an adjustable charger. The adjustable charger can include a base portion and an adjustable cradle coupled to the base portion. The adjustable cradle can receive a single unit electronic device having a display or a flip-type electronic device having a display. The adjustable cradle can position the single unit electronic device in a first viewing position and can position the flip-type electronic device in a second viewing position.

The adjustable charger can further include a charging receptacle that can receive a corresponding charging receptacle on the flip-type electronic device or the single unit electronic device. As an example, the charging receptacle of the adjustable charger can be incorporated in the adjustable cradle.

In one arrangement, the base portion can have a top surface having a curved portion, and the adjustable cradle can have a curved portion that is at least substantially equivalent to the curved portion of the base portion. In addition, the base portion can have at least one projection, and the adjustable cradle can have at least one corresponding track that receives the projection. The track can slide along the projection when the adjustable cradle is moved. As an example, the adjustable charger can be a desktop charger, and the base portion can be designed to rest on a substantially flat surface.

The adjustable charger can further include a release mechanism that can permit the adjustable cradle to move from the first viewing position of the single unit electronic device to the second viewing position of the flip-type electronic device. The release mechanism can also lock the adjustable cradle in the first viewing position of the single electronic device and in the second viewing position of the flip-type electronic device.

As another example, the single unit electronic device can be a monolith mobile communications unit, and the flip-type electronic device can be a flip-type mobile communications unit having a base portion and a flip portion. In another arrangement, the first viewing position can be an optimal viewing position for the display of the single unit electronic device. Similarly, the second viewing position can be an optimal viewing position of the flip-type electronic device.

The present invention also concerns another adjustable charger. This adjustable charger can include a base portion and an adjustable cradle coupled to the base portion. The adjustable portion can receive a first electronic device or a second electronic device. Also, the adjustable cradle can move along a plurality of settings and can set the first electronic device in a first position and can set the second electronic device in a second position.

As an example, the first electronic device can be a single unit electronic device having a display, and the second electronic device can be a flip-type electronic device having a display. As another example, the first position can be a viewing position for the display of the single unit electronic device, and the second position can be a viewing position for the display of the flip-type electronic device.

The present invention also concerns a method of adjusting an adjustable charger. The method can include the step of placing a single unit electronic device or a flip-type electronic device on an adjustable cradle. If the single unit electronic device is placed on the adjustable cradle, the method can further include the step of moving the adjustable cradle to position the single unit electronic device in a first viewing position. Conversely, if the flip-type electronic device is placed on the adjustable cradle, the method can include the step of moving the adjustable cradle to position the flip-type electronic device in a second viewing position.

The adjustable charger may include a charging receptacle. If so, the method can further include the steps of coupling the single unit electronic device or the flip-type electronic device to the charging receptacle and charging the single unit electronic device or the flip-type electronic device. As an example, the first viewing position can be an optimal viewing position for a display of the single unit electronic device. As another example, the second viewing position can be an optimal viewing position for a display of the flip-type electronic device.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates perspective views of an adjustable charger in accordance with an embodiment of the inventive arrangements;

FIG. 2 illustrates a top view of an adjustable charger in accordance with an embodiment of the inventive arrangements;

FIG. 3 illustrates a front view of an adjustable charger in accordance with an embodiment of the inventive arrangements;

FIG. 4 illustrates side views of an adjustable charger in accordance with an embodiment of the inventive arrangements;

FIG. 5 illustrates an adjustable charger supporting a flip-type electronic device in accordance with an embodiment of the inventive arrangements;

FIG. 6 illustrates an adjustable charger supporting a single unit electronic device in accordance with an embodiment of the inventive arrangements; and

FIG. 7 illustrates a method of operating an adjustable charger in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns an adjustable charger and a method of using same. The adjustable charger can include a base portion and an adjustable cradle that can receive a single unit electronic device having a display or a flip-type electronic device having a display. The adjustable cradle can position the single unit electronic device in a first viewing position and can position the flip-type electronic device in a second viewing position. In one arrangement, the first viewing position can be an optimal viewing position for a display of the single unit electronic device. In addition, the second viewing position can be an optimal viewing position for a display of the flip-type electronic device. Thus, a user is permitted to optimally view various types of display-laden electronic devices using the inventive apparatus.

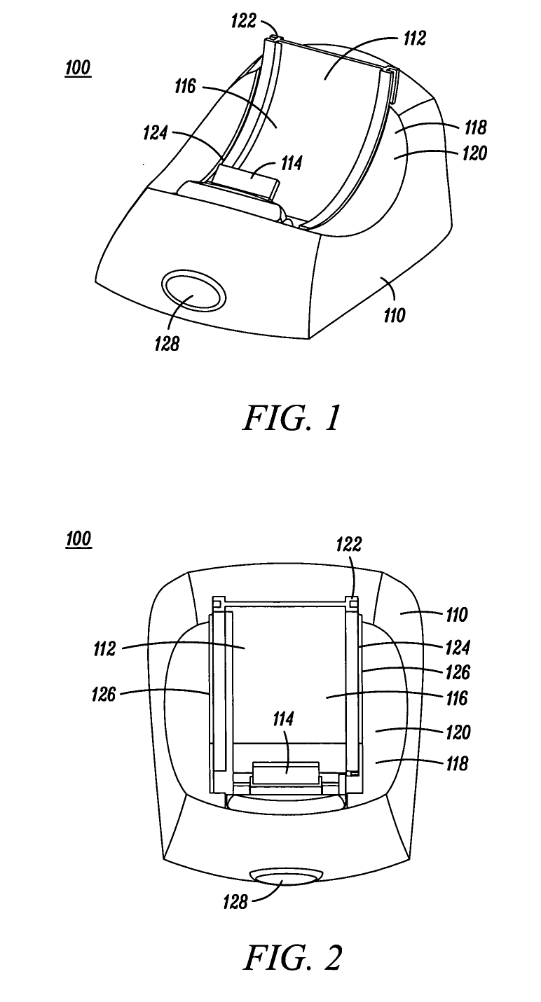

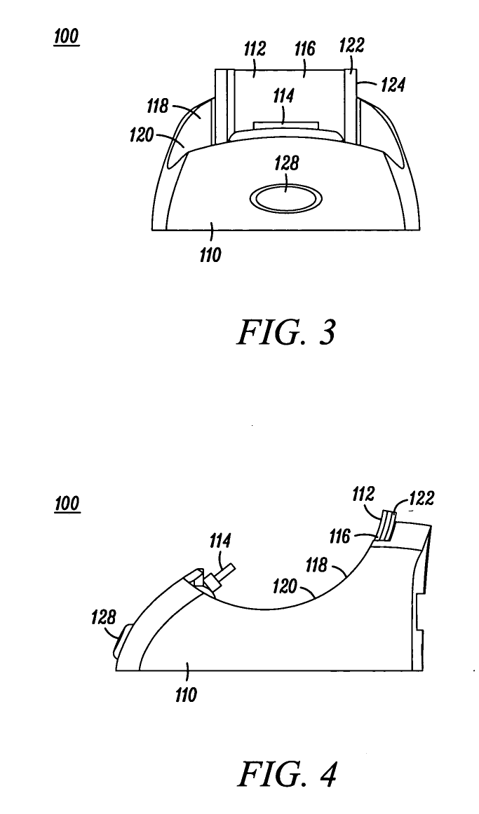

Referring to FIGS. 1-6, various views of an adjustable charger 100 are shown. In one arrangement, the adjustable charger 100 can include a base portion 110 and an adjustable cradle 112 in which the adjustable cradle 112 can be coupled to the base portion 110. As an example, the adjustable charger 100 can be a desktop charger, and the base portion 110 can be designed to rest on a flat surface. In another arrangement, the adjustable charger 100 can include a charging receptacle 114, which can be incorporated in the adjustable cradle 112. Of course, the invention is not so limited, as the charging receptacle 114 can be incorporated into any other suitable area or component of the adjustable charger 100.

In another arrangement, the adjustable cradle 112 can have a curved portion 116, and the curved portion 116 can be any suitable length and can have any suitable arc. The base portion 110 can have a top surface 118, which can also include a curved portion 120. As an example, the curved portion 116 of the adjustable cradle 112 can be at least substantially equivalent to the curved portion 120 of the top surface 118. Specifically, the arc of the curved portion 116 can be at least substantially equivalent to that of the curved portion 120.

The adjustable cradle 112 can also include one or more tracks 122, which can run along at least a portion of the edges 124 of the adjustable cradle 112. In addition, the base portion 110 can include a projection 126 (best shown in FIGS. 2, 5 and 6). The tracks 122 can slide along their corresponding projections 126 when the adjustable cradle 112 is moved. Thus, the adjustable cradle 112 can move along a plurality of positions, which can be determined by the design of the tracks 122 and the projections 126. It is understood, however, that other suitable mechanisms can be used to enable the adjustable cradle 112 to move between a plurality of positions, as the invention is in no way limited to the design described above.

The adjustable charger 100 can also include a release mechanism 128, which can be incorporated into the base portion 110 or any other suitable component of the adjustable charger 100. In one arrangement, the release mechanism 128 can lock the adjustable cradle 112 into any suitable position. As an example, the release mechanism 128 may include a spring-loaded hook (not shown) that can selectively engage one or more teeth (not shown) that are positioned on the adjustable cradle 112. For example, when the spring-loaded hook engages one or more of the teeth, the release mechanism 128 can lock the adjustable cradle 112 into a first position. In contrast, when the spring-loaded hook disengages the one or more teeth, the release mechanism 128 can permit the adjustable cradle 112 to move from the first position to a second position.

A user can cause the disengagement of the spring-loaded hook and the teeth simply by pressing the release mechanism 128 and holding it down. The user can then move the adjustable cradle 112 into the desired position. The user can then stop pressing the release mechanism 128, and the spring-loaded hook can engage the teeth of the adjustable cradle 112. This engagement, as described earlier, can lock the adjustable cradle 112 in the desired position. Again, it must be noted that the invention is not limited in this regard, as those of skill in the art will appreciate that any other suitable device or system can be used to selectively engage the adjustable cradle 112.

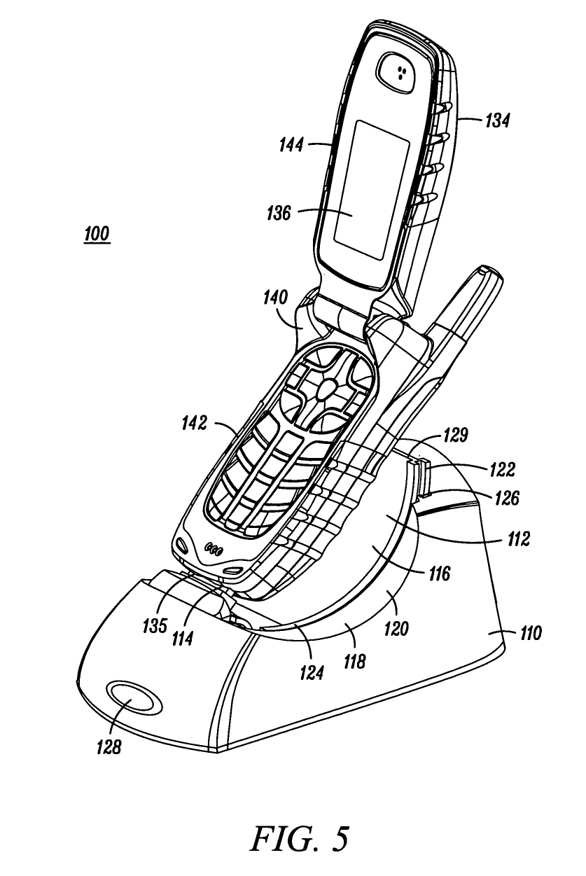

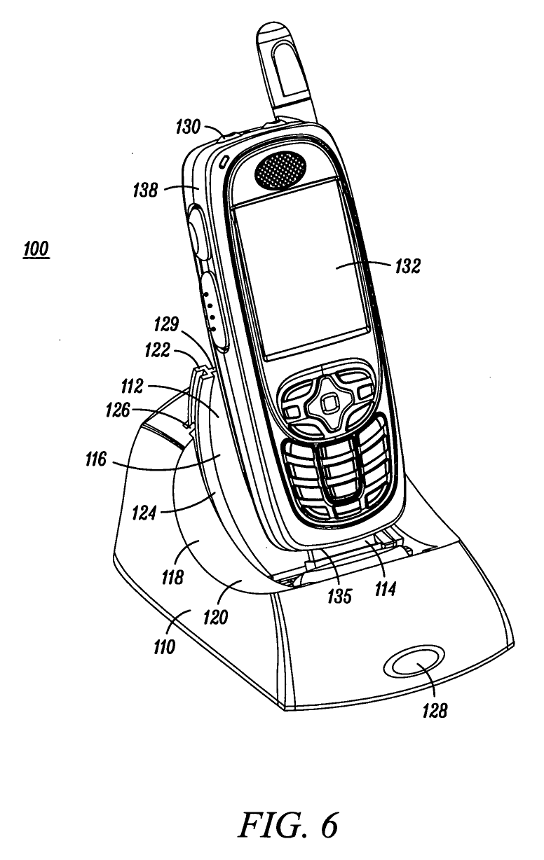

In one arrangement, referring to FIGS. 5 and 6, the adjustable cradle 112 can receive a single unit electronic device 130 having a display 132 or a flip-type electronic device 134 having a display 136. A single unit electronic device can be defined as any electronic device whose main components are primarily housed within a single body. An example of a single unit electronic device 130 is a monolith mobile communications unit 138, as shown in FIG. 6.

A flip-type electronic device can be defined as any electronic device whose main components are housed within two or more distinct bodies. An example of a flip-type electronic device 134 is a flip-type mobile communications unit 140 having a base portion 142 and a flip portion 144, as shown in FIG. 5. Both the flip-type electronic device 134 and the single unit electronic device 130 can include charging receptacles 135 that can receive the charging receptacle 114 of the adjustable charger 100. It is understood, however, that the invention is not limited to receiving single unit or flip-type electronic devices, as the adjustable charger 100 can be designed to receive other suitable devices.

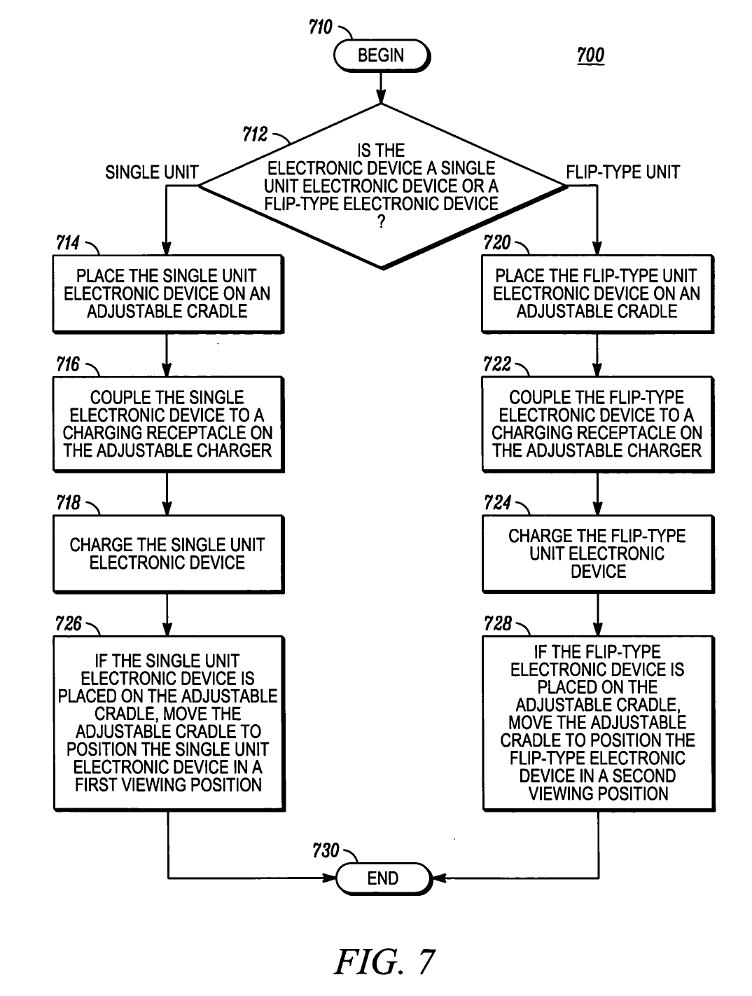

Because the construction of the single unit electronic device 130 and the flip-type electronic device 134 are different, the displays 132, 136 of these components may be best viewed at different angles with respect to the viewer. Referring to FIG. 7, a method 700 will be used to explain an example of the operation of an adjustable charger. To describe the method 700, reference will be made to FIGS. 1-6, although it is understood that the method 700 can be implemented in any other suitable device or system using other suitable components. Moreover, the invention is not limited to the order in which the steps are listed in the method 700. In addition, the method 700 can contain a greater or a fewer number of steps than those shown in FIG. 7.

At step 710, the method 700 can begin. At step 712 it can be determined whether the electronic device to be engaged with the adjustable charger 100 is, for example, a single unit electronic device 130 or a flip-type electronic device 134. If the electronic device is a single unit electronic device 130, then the single unit electronic device 130 can be placed on the adjustable cradle 112, as shown at step 714, and can be coupled to the charging receptacle 114, as shown at step 716. The single unit electronic device 130 can then be charged, as shown at step 718.

Similarly, if the electronic device is a flip-type electronic device 134, then the flip-type electronic device 134 can be placed on the adjustable cradle 112, as shown at step 720, and can be coupled to the charging receptacle 114, as shown at step 722. In either the single unit electronic device or flip-type electronic device arrangements, a top portion 129 of the curved portion 112 can support the back side of either electronic device (see FIG. 5 or 6) when coupled to the charging receptacle 114. Alternatively, the charging receptacle 114 alone, or any other suitable mechanism, can hold the electronic device in place. At step 724, the flip-type electronic device 134 can be charged. As an example, both the single unit electronic device 130 and the flip-type electronic device 134 can be coupled to the charging receptacle 114 through their charging receptacles 135.

At step 726, if the single unit electronic device 130 is placed on the adjustable cradle 112, then the adjustable cradle 112 can be moved to position the single unit electronic device 130 in a first viewing position. At step 728, if the flip-type electronic device 134 is placed on the adjustable cradle 112, then the adjustable cradle 112 can be moved to position the flip-type electronic device 134 in a second viewing position. The method 700 can then end at step 730.

As an example, a user can press or otherwise activate the release mechanism 128 and can move the adjustable cradle 112 along a plurality of positions until the single unit electronic device 130 is in a first viewing position (see FIG. 6). Once in the first viewing position, the user can release the release mechanism 128, which can lock the adjustable cradle 112 in place. In one arrangement, this first viewing position can be an optimal viewing position for the display 132 of the single unit electronic device 130. An optimal viewing position can be the viewing position with respect to a viewer at which the viewer most clearly sees a display.

As another example, a user can press or otherwise activate the release mechanism 128 and can move the adjustable cradle 112 along a plurality of positions until the flip-type electronic device 134 is in a second viewing position (see FIG. 5). Once in the second viewing position, the user can release the release mechanism 128 to lock the adjustable cradle 112 in place. In one arrangement, this second viewing position can be an optimal viewing position for the display 136 of the flip-type electronic device 134. Because displays of different electronic devices may be best viewed at different angles, the adjustable cradle 112 can enable a user to both charge different electronic devices and view their displays at optimal viewing positions.

It is understood, however, that the invention is not limited to the electronic devices described above, as the adjustable charger 100 can be designed to accept other suitable devices. Moreover, the charging process does not necessarily have to be conducted while the adjustable cradle 112 is supporting an electronic device.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present invention may also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. An adjustable charger, comprising:
a base portion; and
an adjustable cradle coupled to the base portion, wherein the adjustable cradle receives a single unit electronic device having a display or a flip-type electronic device having a display, wherein the adjustable cradle positions the single unit electronic device in a first viewing position and positions the flip-type electronic device in a second viewing position.

2. The adjustable charger according to claim 1, further comprising a charging receptacle that receives a corresponding charging receptacle on the flip-type electronic device or the single unit electronic device.

3. The adjustable charger according to claim 2, wherein the charging receptacle of the adjustable charger is incorporated in the adjustable cradle.

4. The adjustable charger according to claim 1, wherein the base portion has a top surface having a curved portion and wherein the adjustable cradle has a curved portion that is at least substantially equivalent to the curved portion of the base portion.

5. The adjustable charger according to claim 1, wherein the base portion has at least one projection and the adjustable cradle has at least one corresponding track that receives the projection and wherein the track slides along the projection when the adjustable cradle is moved.

6. The adjustable charger according to claim 1, wherein the adjustable charger is a desktop charger and the base portion is designed to rest on a substantially flat surface.

7. The adjustable charger according to claim 1, further comprising a release mechanism that permits the adjustable cradle to move from the first viewing position of the single unit electronic device to the second viewing position of the flip-type electronic device.

8. The adjustable charger according to claim 7, wherein the release mechanism locks the adjustable cradle in the first viewing position of the single electronic device and in the second viewing position of the flip-type electronic device.

9. The adjustable charger according to claim 1, wherein the single unit electronic device is a monolith mobile communications unit and the flip-type electronic device is a flip-type mobile communications unit having a base portion and a flip portion.

10. The adjustable charger according to claim 1, wherein the first viewing position is an optimal viewing position for the display of the single unit electronic device and the second viewing position is an optimal viewing position of the flip-type electronic device.

11. An adjustable charger, comprising:
a base portion; and
an adjustable cradle coupled to the base portion, wherein the adjustable portion receives a first electronic device or a second electronic device, wherein the adjustable cradle moves along a plurality of settings and sets the first electronic device in a first position and sets the second electronic device in a second position.

12. The adjustable charger according to claim 11, wherein the first electronic device is a single unit electronic device having a display and the second electronic device is a flip-type electronic device having a display, wherein the first position is a viewing position for the display of the single unit electronic device and the second position is a viewing position for the display of the flip-type electronic device.

13. A method of adjusting an adjustable charger, comprising:
placing a single unit electronic device or a flip-type electronic device on an adjustable cradle;
if the single unit electronic device is placed on the adjustable cradle, moving the adjustable cradle to position the single unit electronic device in a first viewing position; and
if the flip-type electronic device is placed on the adjustable cradle, moving the adjustable cradle to position the flip-type electronic device in a second viewing position.

14. The method according to claim 13, wherein the adjustable charger includes a charging receptacle and the method further comprises:
coupling the single unit electronic device or the flip-type electronic device to the charging receptacle; and
charging the single unit electronic device or the flip-type electronic device.

15. The method according to claim 13, wherein the first viewing position is an optimal viewing position for a display of the single unit electronic device and the second viewing position is an optimal viewing position for a display of the flip-type electronic device.
